(19) United States
(12) Patent Application Publication
(10) Pub. No.: US 2017/0040113 A1
(43) Pub. Date: Feb. 9, 2017

(54) CAPACITOR

(71) Applicant: Murata Manufacuting Co., Ltd., Nagaokakyo-shi (JP)

(72) Inventors: HIROMASA SAEKI, Nagaokakyo-shi (JP); Naoki Iwaji, Nagaokakyo-shi (JP)

(21) Appl. No.: 15/228,063

(22) Filed: Aug. 4, 2016

(30) Foreign Application Priority Data
Aug. 6, 2015 (JP) 2015-156256

(51) Int. Cl. H01G 4/30; H01G 4/012; H01G 4/018; H01G 4/008

(52) U.S. Cl. CPC H01G 4/306; H01G 4/008; H01G 4/012; H01G 4/018

(57) ABSTRACT

A capacitor that includes a conductive porous base material having a plurality of pores; a dielectric layer on the conductive porous base material; and an upper electrode on the dielectric layer and sealing openings of at least some of the plurality of pores of the conductive porous base material.

### CROSS REFERENCE TO RELATED APPLICATIONS

The present application claims priority to Japanese Patent Application No. 2015-156256, filed Aug. 6, 2015, the entire contents of which are incorporated herein by reference.

### BACKGROUND OF THE INVENTION

1. Field of the Invention

The present invention relates to a capacitor.

2. Description of the Related Art

In recent years, with higher-density mounting of electronic devices, capacitors with higher electrostatic capacitance have been required. As such a capacitor, for example, Nanotechnology 26 (2015) 064002 discloses therein a capacitor that has an Al₂O₃ layer as a dielectric layer and a TiN layer as an upper electrode formed on a porous body composed of a carbon nanotube with the use of an atomic layer deposition method (ALD method: Atomic Layer Deposition).

### SUMMARY OF THE INVENTION

The capacitor that uses a porous body as in Nanotechnology 26 (2015) 064002 has high electrostatic capacitance, but has mechanical strength decreased. This problem is true of not only the porous body composed of the carbon nanotube, but also metallic porous bodies (for example, aluminum porous bodies), porous silicon, and anodized porous alumina that have a similar three-dimensional structure.

An object of the present invention is to provide a capacitor which has high mechanical strength even in the case of using a porous body which has a three-dimensional structure.

The present inventors have found, as a result of carrying out earnest studies to solve the above problem, that the mechanical strength of a capacitor is improved by filling, with an upper electrode, openings of at least some pores in a porous body, thereby achieving the present invention.

According to a first aspect of the present invention, a capacitor is provided which includes a conductive porous base material having a plurality of pores; an upper electrode sealing openings of some of the plurality of pores of the conductive porous base material; and a dielectric layer between the conductive base material and the upper electrode.

According to a second aspect of the present invention, a method for manufacturing a capacitor that includes providing a conductive porous base material having a plurality of pores; and forming an upper electrode by an atomic layer deposition method using a Ti[N(CH₃)₂]₄ gas and a NH₃ gas as raw material gases when the conductive porous base material has a temperature of 300° C. to 350° C. The upper electrode formed in this manner seals openings of at least some of the plurality of pores of the conductive porous base material.

According to a third aspect of the present invention, a method for manufacturing a capacitor that includes providing a conductive porous base material having a plurality of pores; and forming an upper electrode by an atomic layer deposition method using a Ti[N(CH₃)₂]₄ gas or a TiCl₄ gas, and a NH₃ gas as raw material gases, and setting a raw material gas exhaust time to 0.8 to 0.9 times as long as a shortest exhaust time in the atomic layer deposition method. The upper electrode formed in this manner seals openings of at least some of the plurality of pores of the conductive porous base material.

According to another aspect of the present invention, the second and third methods can be combined such that the conductive porous base material has a temperature of 300° C. to 350° C. and gases, and the raw material gas exhaust time is set to 0.8 to 0.9 times as long as the shortest exhaust time in the atomic layer deposition method.

According to the present invention, a capacitor which has high mechanical strength can be provided by filling, with the upper electrode, at least some pores in the conductive porous base material.

### BRIEF DESCRIPTION OF THE DRAWINGS

FIG. 1 is a schematic cross-sectional view of a capacitor 1 according to an embodiment of the present invention;

FIG. 2 is a diagram schematically illustrating a layered structure in the capacitor 1;

FIG. 3 is a diagram schematically showing a cross-sectional view of a pore in a capacitor sample according to Example 1; and

FIG. 4 is a diagram schematically showing a cross-sectional view of a pore in a capacitor sample according to Comparative Example 1.

### DETAILED DESCRIPTION OF PREFERRED EMBODIMENTS OF THE INVENTION

A capacitor according to the present invention will be described in detail below with reference to the drawings. However, the capacitor according to the present embodiment and the shapes and arrangement of respective constructional elements are not limited to the examples shown in the figures.

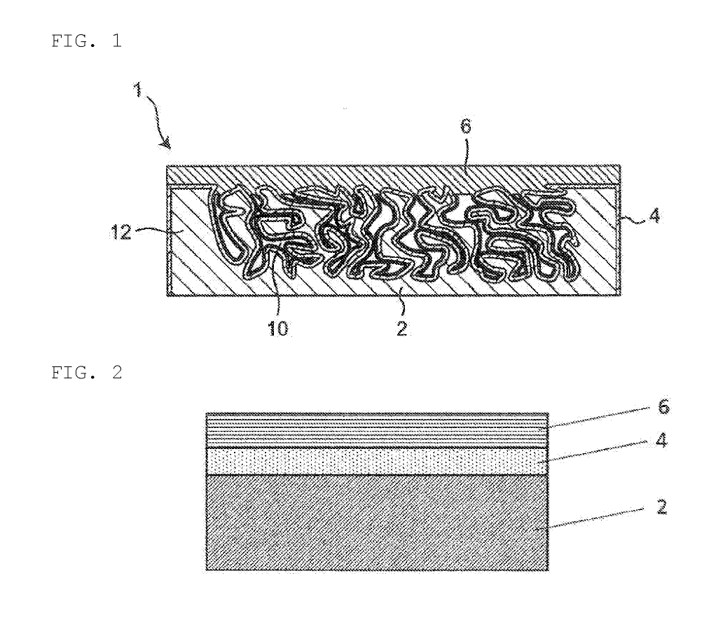

FIG. 1 shows a schematic cross-sectional view of a capacitor 1 according to the present embodiment, and FIG. 2 schematically shows the layered structure (that is, the layered structure of a conductive porous base material 2, a dielectric layer 4, and an upper electrode 6) of the capacitor 1. The capacitor 1 according to the present embodiment has a substantially cuboid shape, and as shown in FIGS. 1 and 2, schematically has the conductive porous base material 2 including a porous part 10 and a low-porosity part 12, the dielectric layer 4 formed on the conductive porous base material 2, and the upper electrode 6 formed on the dielectric layer 4.

The upper electrode 6 is formed so as to seal openings of pores in the conductive porous base material 2. The conductive porous base material 2 can function as an electrode, and is opposed to the upper electrode 6 with the dielectric layer 4 interposed therebetween. Charges can be accumulated in the dielectric layer 4 by applying a voltage to the conductive porous base material 2 and the upper electrode 6.

The conductive porous base material 2 has a porous part 10 including a large number of pores. The porosity in the porous part 10 can be preferably 20% or more, more preferably 30% or more, further preferably 50% or more, and yet further preferably 60% or more. Increasing the porosity can further increase the capacitance. In addition, from the perspective of increasing the mechanical strength, the porosity of the porous part 10 can be preferably 90% or less, and more preferably 80% or less.

The term “porosity” in this specification refers to the proportion of voids in the porous part. It is to be noted that while the dielectric layer, the upper electrode, and the like can be present in pores of the porous part, the porosity in this specification means the porosity in the absence of the dielectric layer, the upper electrode, and the like, that is, the porosity in consideration of only the conductive porous base material. The porosity can be measured in the following way.

A sample of the porous part for TEM (Transmission Electron Microscope) observation is prepared by a FIB (Focused Ion Beam) micro-sampling method. A region of approximately 3 μm×3 μm in a cross section of the sample is observed, and subjected to measurement by STEM (Scanning Transmission Electron Microscopy)—EDS (Energy Dispersive X-ray Spectrometry) mapping analysis. The proportion of the area without the base material is regarded as the porosity in the visual field of the mapping measurement. The average for measurements at any three points is regarded as the porosity.

The porous part 10 is not particularly limited, but preferably has an expanded surface ratio of 30 times or more and 10,000 times or less, more preferably 50 times or more and 5,000 times or less, for example, 200 times or more and 600 times or less. In this regard, the expanded surface ratio refers to the ratio of the surface area per unit projected area. The surface area per unit projected area can be obtained from the amount of nitrogen adsorption at a liquid nitrogen temperature with the use of a BET specific surface area measurement system.

The conductive porous base material 2 has the low-porosity part 12. While the low-porosity part 12 is illustrated on either side of the conductive porous base material 2 in FIG. 1, the low-porosity part 12 is present so as to surround the porous part 10. More specifically, the low-porosity part is also present in front of and behind the drawing. The low-porosity part 12 is a region that is lower in porosity than the porous part 10. It is to be noted that there is no need for the low-porosity part 12 to have pores.

The low-porosity part 12 contributes to improvement of mechanical strength of the capacitor. The porosity of the low-porosity part 12 is preferably 60% or less of the porosity of the porous part 10, and more preferably 50% or less of the porosity of the porous part 10, from the perspective of increasing the mechanical strength. For example, the porosity of the low-porosity part 12 is preferably 20% or less, and more preferably 10% or less. In addition, the low-porosity part 12 may have a porosity of 0%.

The low-porosity part 12 can preferably account for 5 volume % or more and 50 volume % or less, more preferably 8 volume % or more and 40 volume % or less, and further preferably 10 volume % or more and 35 volume % or less, for example, 15 volume % or more and 30 volume % or less, or 20 volume % or more and 30 volume % or less of the conductive porous base material 2.

The presence of the low-porosity part 12 at 5 volume % or more improves the mechanical strength of the capacitor. In addition, the adjustment of the low-porosity part 12 to 50 volume % or less can further increase the electrostatic capacitance.

It is to be noted the conductive porous base material 2 according to the present embodiment has the low-porosity part 12, but the low-porosity part is not an essential element. Further, even in the case of providing the low-porosity part 12, there is no particular limitation in terms of location, the number of parts located, size, shape, and the like.

The material and composition of the conductive porous base material 2 are not limited as long as the porous part 10 has a conductive surface. For example, the conductive porous base material 2 may be a conductive metallic porous base material formed from a conductive metal, or a porous base material including a conductive layer formed on a surface of a porous part of a non-conductive porous material, such as a porous silica material, a porous carbon material, or a porous ceramic sintered body.

In a preferred embodiment, the conductive porous base material 2 is a conductive metallic porous base material. Examples of the metal constituting the conductive metallic porous base material include, for example, metals such as aluminum, tantalum, nickel, copper, titanium, niobium, and iron, and alloys such as stainless steel and duralumin. Preferably, the conductive porous base material 2 is an aluminum porous base material.

The conductive porous base material 2 has the porous part only at one principal surface in the present embodiment, but the present invention is not limited thereto. More specifically, the porous part may be present at two principal surfaces. In addition, the porous part is not particularly limited in terms of location, the number of parts located, size, shape, and the like.

In the capacitor 1 according to the present embodiment, the dielectric layer 4 is formed on the conductive porous base material 2.

The material that forms the dielectric layer 4 is not particularly limited as long as the material has an insulating property, but preferably, examples thereof include metal oxides such as AlOₓ (for example, Al₂O₃), SiOₓ (for example, SiO₂), AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ, and SiAlOₓ; metal nitrides such as AlNₓ, SiNₓ, and AlScNₓ; or metal oxynitrides such as AlOₓN_{y}, SiOₓN_{y}, HfSiOₓN_{y}, and SiCₓO_{y}N_{z}; AlOₓ, SiOₓ, SiOₓN_{y}, and HfSiOₓ are preferred, and AlOₓ (representatively, Al₂O₃) is more preferred. It is to be noted that the formulas mentioned above are merely intended to represent the constitutions of the materials, but not intended to limit the compositions. More specifically, the x, y, and z attached to O and N may have any value larger than 0, and the respective elements including the metal elements may have any presence proportion.

The thickness of the dielectric layer 4 is not particularly limited, but for example, preferably 5 nm or more and 100 nm or less, and more preferably 10 nm or more and 50 nm or less. The adjustment of the thickness of the dielectric layer to 5 nm or more can enhance the insulating property, thereby making it possible to further reduce the leakage current. In addition, the adjustment of the thickness of the dielectric layer to 100 nm or less makes it possible to achieve higher electrostatic capacitance.

The dielectric layer is preferably formed by a gas phase method, for example, a vacuum deposition method, a chemical vapor deposition (CVD: Chemical Vapor Deposition) method, a sputtering method, an atomic layer deposition (ALD: Atomic Layer Deposition) method, a pulse laser deposition method (PLD: Pulsed Laser Deposition), or the like. Because a more homogeneous and denser film can be formed even in fine pores of the porous member, the CVD method or the ALD method is more preferred, and the ALD method is particularly preferred.

In the capacitor 1 according to the present embodiment, the upper electrode 6 is formed on the dielectric layer 4.

The material constituting the upper electrode 6 is not particularly limited as long as the material is conductive, but examples thereof include, Ni, Cu, Al, W, Ti, Ag, Au, Pt, Zn, Sn, Pb, Fe, Cr, Mo, Ru, Pd, and Ta and alloys thereof, e.g., CuNi, AuNi, AuSn, and metal nitrides and metal oxynitrides such as TiN, TiAlN, TiON, TiAlON, and TaN, conductive polymers (for example, PEDOT(poly(3,4-ethylenedioxythiophene)), polypyrrole, polyaniline), TiN or TiAlN is preferred, and TiN is more preferred.

The upper electrode 6 is formed so as to seal openings of pores in the conductive porous base material 2. Forming the upper electrode 6 as just described improves the mechanical strength of the capacitor, and reduces the equivalent series resistance (ESR: Equivalent Series Resistance).

The pores are preferably filled with the upper electrode 6 at least down to a depth of 10 μm, preferably at least down to a depth of 15 μm, and more preferably at least down to a depth of 20 μm, from the openings of the pores, and further preferably to fill the entire pores. Filling the pores with the upper electrode as just described further improves the mechanical strength of the capacitor, and reduces the ESR.

The depth filled with the upper electrode can be measured in the following way. A sample of the porous part for TEM observation is prepared by a FIB micro-sampling method. A cross section of the sample is observed, and subjected to measurement by STEM-EDS analysis. The shortest distance from the midpoint of a line connecting both ends of a pore opening through the upper electrode filling the pore to a void formed in the pore by being filled with the upper electrode is regarded as the filling depth of the upper electrode.

The upper electrode 6 only has to seal at least some of pores present in the conductive porous base material 2. In a preferred embodiment, the upper electrode 6 seals openings of 50% or more, preferably 70% or more, more preferably 80% or more, further preferably 90% or more, and yet further preferably all of pores present in the conductive porous base material 2. The upper electrode seals 50% or more of pores present in the conductive porous base material, thereby improving the mechanical strength of the capacitor, and reducing the ESR.

The thickness of the upper electrode 6 is not particularly limited, but for example, at the thinnest part, preferably 3 nm or more, and more preferably 10 nm or more. The adjustment of the thickness of the upper electrode to 3 nm or more can reduce the resistance of the upper electrode itself.

The method for forming the upper electrode 6 is not particularly limited as long as the method can coat the dielectric layer 4, and seal openings of pores in the conductive porous base material 2, and examples of the method include, for example, methods such as an ALD method, a chemical vapor deposition (CVD: Chemical Vapor Deposition) method, plating, bias sputtering, a Sol-Gel method, and conductive polymer filling. Preferably, the upper electrode is formed by the ALD method. The use of the ALD method can increase the capacitance.

In a preferred embodiment, the upper electrode is a TiN layer formed by an ALD method with the use of, as reaction gases, a Ti[N(CH₃)₂]₄ (tetrakis dimethylamino titanium) or TiCl₄ (titanium tetrachloride) gas, and a NH₃ (ammonia) gas.

The temperature of the conductive porous base material in deposition by an atomic layer deposition method in the case of Ti[N(CH₃)₂]₄ (tetrakis dimethylamino titanium) as a raw material gas is preferably 300° C. to 350° C., and more preferably 320° C. to 350° C. The deposition at the temperature can seal openings of pores with the use of an ALD method. While the present invention is not bound by any theory, it is believed that the deposition at the temperature decomposes the raw material gases to make the deposition rate faster, thus forming thicker films near pore entrances, and sealing the openings.

The exhaust time for the raw material gas in the atomic layer deposition method is 0.8 to 0.9 times as long as the shortest exhaust time. The deposition achieved by adjusting the exhaust time as just described can seal openings of pores with the use of an ALD method. While the present invention is not bound by any theory, it is believed that the deposition with the exhaust time adjusted as just described supplies, with some of a raw material gas (for example, TiCl₄) left near openings of pores, another raw material gas (for example, NH₃), and thus reacts both of the gases near the openings, thereby developing a CVD reaction, and sealing the openings.

It is to be noted the gas exhaust time means pressure reduction time to exhaust raw material gas from pores after supplying the raw material gas to the pores in the conductive porous base material. The shortest exhaust time refers to time required for exhaust, from the pores, of substantially all of the raw material gas supplied to the pores. The shortest exhaust time can vary depending on conditions, and is experimentally derived.

While the capacitor according to the present embodiment has been described above with reference to the capacitor according to the embodiment as mentioned above, the present invention is not to be considered limited thereto, and various modifications can be made thereto.

For example, in an embodiment, the capacitor according to the present invention may have an extended electrode on the upper electrode 6.

The material constituting the extended electrode is not particularly limited, but example thereof include, for example, metals such as Au, Pb, Ag, Sn, Ni, and Cu, and alloys, as well as conductive polymers. The method for forming the extended electrode 14 is not particularly limited, but for example, a CVD method, electrolytic plating, electroless plating, vapor deposition, sputtering, baking of a conductive paste, and the like can be used, and electrolytic plating or electroless plating is preferred.

In another embodiment, the capacitor according to the present invention may have a layer other than the layers presented in the embodiment described above.

For example, in an embodiment, another layer may be present between the base material and the dielectric layer.

In another embodiment, another layer may be present between the dielectric layer and the upper electrode.

In another embodiment, there may be further an electrode layer and a dielectric layer between the dielectric layer and the upper electrode layer.

The capacitor according to the present invention can be manufactured by a method including the formation of the upper electrode with the use of an atomic layer deposition method where the conductive porous base material during the deposition has a temperature of 300° C. to 350° C., with the use of a Ti[N(CH₃)₂]₄ gas and a NH₃ gas as raw material gases.

As another method, the capacitor according to the present invention can be manufactured by a method characterized in that the upper electrode is formed with the use of an atomic layer deposition method where the exhaust time for the raw material gas is 0.8 to 0.9 times as long as the shortest exhaust time, with the use of a Ti[N(CH₃)₂]₄ gas or a TiCl₄ gas, and a NH₃ gas as raw material gases.

In a preferred embodiment, the capacitor according to the present invention can be manufactured by a method including the formation of the upper electrode through the use of an atomic layer deposition method where the temperature during the deposition is 300° C. to 350° C., the exhaust time for the raw material gas is 0.8 to 0.9 times as long as the shortest exhaust time, with the use of a Ti[N(CH₃)₂]₄ gas or a TiCl₄ gas, and a NH₃ gas as raw material gases.

The appropriate adjustment of the temperature and exhaust time in the deposition can adjust the depth of the upper electrode present in pores.

According to the method mentioned above, the upper electrode material can seal pores at the same time while forming the upper electrode over the entire dielectric layer by an ALD method. This method is advantageous that one operation can form the upper electrode and rapidly fill pores.

### EXAMPLES

### Example 1

Prepared was a commercial aluminum etching foil with an expanded surface ratio of 250 times. For this foil, a dielectric layer of Al₂O₃ was formed by an ALD method. Specifically, a step of alternately supplying a trimethyl aluminum (Al(CH₃)₃) gas and a water vapor (H₂O) gas to the foil was repeated a predetermined number of times, thereby forming an A1₂O₃ layer on the foil. It is to be noted that the temperature in the deposition of the Al₂O₃ layer was adjusted to 250° C.

Next, on the dielectric layer, an upper electrode of TiN was formed by the ALD method. Specifically, a step of alternately supplying a tetrakis dimethylamino titanium (TDMAT, Ti[N(CH₃)₂]₄) gas and an ammonia (NH₃) gas was repeated a predetermined number of times, thereby forming a TiN layer. The temperature in the formation of the TiN layer was adjusted to 325° C. In accordance with this procedure, a capacitor sample was prepared which was structured as shown in FIG. 1.

### Comparative Example 1

In the same way as in Example 1 except that the temperature in the deposition of the TiN layer was adjusted to 250° C., a capacitor sample was prepared which was structured as shown in FIG. 1.

Evaluation

Cross-Section Observation

The samples prepared in the way described above according to Example 1 and Comparative Example 1 were subjected to FIB processing with the use of a focused ion beam system (SM13050SE from SII NanoTechnology Inc.), thereby exposing cross sections (near the surfaces of the porous parts) of the aluminum etching foil as the porous base materials, into thin section samples on the order of approximately 60 nm in thickness. The samples were observed with a transmission electron microscope (TEM: Transmission Electron Microscope, JEM-2200FS from JEOL Ltd.). Further, the FIB damage layer produced in processing into the thin section was removed with the use of an Ar ion milling system (PTPSmodel1691 from GATAN, Inc.).

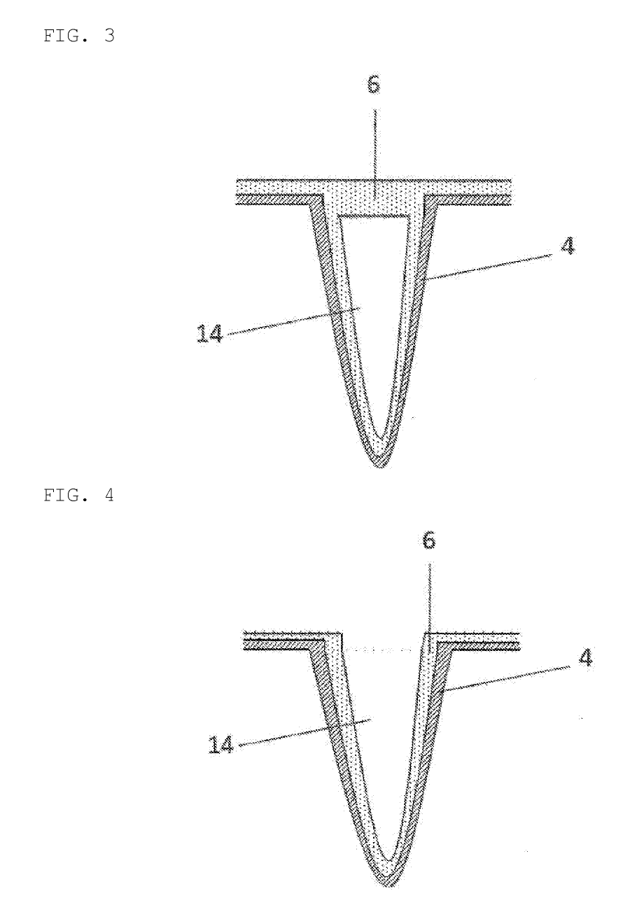

As a result, it has been confirmed that in Example 1, openings of all pores in the porous part were sealed with the TiN layer, and filled with the TiN layer down to a depth of 10 μm into the pores (see FIG. 3). On the other hand, it has been confirmed that in the sample according to Comparative Example 1, the porous part is not filled with TiN, but left open (see FIG. 4).

Strength Test

The samples according to Example 1 and Comparative Example 1 were subjected to a mounting test with an impact force of 10 N with the use of a chip mounter (TCM-3100J from SANYO Electric Co., Ltd.). Thirty pieces were mounted for each of the samples, and it was confirmed with an optical microscope whether the samples were broken or deformed. As a result, it has been confirmed that none of the 30 pieces was broken or deformed in the case of the sample according to the example, whereas 12 pieces were deformed or broken in the case of the sample according to the comparative example.

### Example 2

As in Example 1, aluminum etching foil was prepared, and for this foil, a dielectric layer of Al₂O₃ was formed by an ALD method.

Next, an upper electrode was deposited on the dielectric layer by the ALD method with the use of TiCl₄ and NH₃. Specifically, a TiCl₄ gas was supplied, and thereafter, exhaust was achieved by vacuuming for the excess TiCl₄ gas. Thereafter, a NH₃ gas was supplied, and thereafter, exhaust was achieved by vacuuming for the excess NH₃ gas. This exhaust was repeated a predetermined number of times, thereby coating the entire surface of the porous body with a TiN layer of 3 nm in thickness. It is to be noted that the exhaust time for each of the TiCl₄ gas and the NH₃ gas in this case was set to the experimentally derived shortest time (shortest exhaust time) for sufficient exhaust for each of the TiCl₄ gas and the NH₃ gas.

Then, the vacuuming time for each of TiCl₄ and NH₃ was set to 0.8 to 0.9 times as long as the shortest exhaust time, and the supply of the gases and the vacuuming therefor were repeated a predetermined number of times, thereby preparing a capacitor sample.

Evaluation

Cross-Section Observation

As in Example 1, the sample was subjected to FIB processing, thereby exposing a cross section (near the surface of the porous part) of the aluminum etching foil as the porous base material. The cross section near the surface of the porous part was observed with a transmission electron microscope (TEM: Transmission Electron Microscope). As a result, it has been confirmed that openings of all pores in the porous part were sealed with the TiN layer, and filled with the TiN layer down to a depth of 10 μm into the pores.

Strength Test

As in Example 1, the sample was subjected to a mounting test with an impact force of 10 N with the use of a chip mounter (TCM-3100J from SANYO Electric Co., Ltd.). Thirty pieces were mounted for the sample, and it was confirmed with an optical microscope whether the sample were broken or deformed. As a result, it has been confirmed that none of the 30 pieces was broken or deformed.

From the foregoing, it has been confirmed that openings of pored in the conductive porous base material are filled with the upper electrode, thereby improving the strength of the capacitor.

The capacitor according to the present invention is, because of excellent strength, used for various electronic devices in a preferred manner.

What is claimed is:

1. A capacitor comprising:
a conductive porous base material having a plurality of pores;
an upper electrode sealing openings of at least some of the plurality of pores of the conductive porous base material; and
a dielectric layer between the conductive porous base material and the upper electrode.

2. The capacitor according to claim 1, wherein the upper electrode seals openings of all of the plurality of pores in the conductive porous base material.

3. The capacitor according to claim 1, wherein the upper electrode seals the openings of 50% or more of the plurality of pores in the conductive porous base material.

4. The capacitor according to claim 1, wherein the upper electrode is an atomic deposition layer electrode.

5. The capacitor according to claim 1, wherein the openings of the at least some of the plurality of pores are filled with the upper electrode at least to a depth of 10 μm from the openings thereof.

6. The capacitor according to claim 1, wherein the openings of the at least some of the plurality of pores are filled with the upper electrode at least to a depth of 15 μm from the openings thereof.

7. The capacitor according to claim 1, wherein the openings of the at least some of the plurality of pores are filled with the upper electrode at least to a depth of 20 μm from the openings thereof.

8. The capacitor according to claim 1, wherein a material of the upper electrode is selected from the group consisting of Ni, Cu, Al, W, Ti, Ag, Au, Pt, Zn, Sn, Pb, Fe, Cr, Mo, Ru, Pd, and Ta, and alloys thereof, metal nitrides, metal oxynitrides, and conductive polymers.

9. The capacitor according to claim 1, wherein the upper electrode comprises TiN.

10. A method for manufacturing a capacitor, the method comprising:
heating a conductive porous base material having a plurality of pores to a temperature of 300° C. to 350° C.; and
forming an upper electrode by an atomic layer deposition method using a Ti[N(CH₃)₂]₄ gas or a TiCl₄ gas, and a NH₃ gas as raw material gases so as to seal openings of at least some of the plurality of pores of the conductive porous base material.

11. The method of manufacturing a capacitor according to claim 10, further comprising adjusting the temperature so as to adjust a depth at which the openings of the at least some of the plurality of pores are filled with the upper electrode.

12. The method of manufacturing a capacitor according to claim 11, wherein the temperature is adjusted such that the depth is at least 10 μm from the openings of the at least some of the plurality of pores.

13. The method of manufacturing a capacitor according to claim 10, further comprising forming a dielectric layer between the conductive porous base material and the upper electrode.

14. The method of manufacturing a capacitor according to claim 10, further comprising setting an exhaust time for the raw material gases to 0.8 to 0.9 times as long as a shortest exhaust time of the atomic layer deposition method.

15. The method of manufacturing a capacitor according to claim 10, further comprising adjusting the temperature and the exhaust time so as to adjust a depth at which the openings of the at least some of the plurality of pores are filled with the upper electrode.

16. The method of manufacturing a capacitor according to claim 12, wherein the temperature and the exhaust time are adjusted such that the depth is at least 10 μm from the openings of the at least some of the plurality of pores.

17. A method for manufacturing a capacitor, the method comprising:
providing a conductive porous base material having a plurality of pores; and
forming an upper electrode by an atomic layer deposition method using a Ti[N(CH₃)₂]₄ gas or a TiCl₄ gas, and a NH₃ gas as raw material gases by setting an exhaust time for the raw material gases from 0.8 to 0.9 times as long as a shortest exhaust time in the atomic layer deposition method so as to seal openings of at least some of the plurality of pores of the conductive porous base material.

18. The method of manufacturing a capacitor according to claim 17, further comprising adjusting the exhaust time so as to adjust a depth at which the openings of the at least some of the plurality of pores are filled with the upper electrode.

19. The method of manufacturing a capacitor according to claim 18, wherein the exhaust time is adjusted such that the depth is at least 10 μm from the openings of the at least some of the plurality of pores.

20. The method of manufacturing a capacitor according to claim 17, further comprising forming a dielectric layer between the conductive porous base material and the upper electrode.
